(19) United States
(12) Patent Application Publication
(10) Pub. No.: US 2023/0126067 A1
(43) Pub. Date: Apr. 27, 2023

(54) LITHIUM METAL SECONDARY BATTERY

(71) Applicant: HONDA MOTOR CO., LTD., Tokyo (JP)

(72) Inventors: Ken BABA, Saitama (JP); Takeshi FUJINO, Saitama (JP); Naoki SAKASHITA, Saitama (JP)

(21) Appl. No.: 17/931,903

(22) Filed: Sep. 14, 2022

(30) Foreign Application Priority Data
Oct. 15, 2021 (JP) 2021-169430

(51) Int. Cl. H01M 10/0565; H01M 10/0525

(52) U.S. Cl. CPC H01M 10/0565; H01M 10/0525; H01M 2300/0025; H01M 2300/0085

(57) ABSTRACT

Provided is a lithium metal secondary battery, including: a positive electrode; a negative electrode current collector; an electrolyte layer provided between the positive electrode and the negative electrode current collector; an intermediate layer provided between the positive electrode and the negative electrode current collector and including an expandable and contractible, three-dimensional structure; and an ionic liquid held within the expandable and contractible, three-dimensional structure.

This application is based on and claims the benefit of priority from Japanese Patent Application No. 2021-169430, filed on 15 Oct. 2021, the content of which is incorporated herein by reference.

### BACKGROUND OF THE INVENTION

### Field of the Invention

The present invention relates to a lithium metal secondary battery.

### Related Art

Electric vehicles have drawn increased attention not only due to tighter control on exhaust emissions from vehicles for a reduction in adverse impact on the global environment but also due to the need to reduce CO₂ emissions in view of climate-related disasters. Electric vehicles have secondary batteries installed therein. For example, lithium metal secondary batteries have been studied for installation into electric vehicles as they have high energy density.

A known lithium metal secondary battery includes, for example, a negative electrode including a negative electrode current collector, a positive electrode, and a solid electrolyte layer. Negative electrodes for lithium metal secondary batteries include two types: one including a negative electrode current collector and lithium metal bonded to the current collector; and the other called anode-free type that includes a negative electrode current collector having no lithium metal bonded thereto and is designed so that lithium metal will be deposited directly on the current collector.

Unfortunately, during the charge of lithium metal secondary batteries, lithium metal segregation may occur on the negative electrode current collector to cause the growth of lithium metal dendrites. This may result in short circuiting between the positive and negative electrodes and lead to a reduction in the durability of lithium metal secondary batteries.

Thus, a known lithium metal secondary battery further includes a porous body layer including resin, which is provided between the negative electrode current collector and the solid electrolyte layer (see Patent Document 1).

Patent Document 1: Japanese Patent No. 6838521

### SUMMARY OF THE INVENTION

Unfortunately, such a lithium metal secondary battery has insufficient durability because lithium metal deposition will occur (see FIG. 5) between the solid electrolyte layer and the porous body layer to cause a reduction in its capacity retention rate. FIG. 5 shows, from top to bottom, the solid electrolyte layer, the lithium metal layer, the porous body layer, and the negative electrode current collector.

It is an object of the present invention to provide a lithium metal secondary battery having improved durability.

An aspect of the present invention is directed to a lithium metal secondary battery, including: a positive electrode; a negative electrode current collector; an electrolyte layer provided between the positive electrode and the negative electrode current collector; an intermediate layer provided between the positive electrode and the negative electrode current collector and including an expandable and contractible, three-dimensional structure; and an ionic liquid held within the expandable and contractible, three-dimensional structure.

In the lithium metal secondary battery, the electrolyte layer may be provided between the positive electrode and the intermediate layer.

The electrolyte layer may be a solid electrolyte layer.

The expandable and contractible, three-dimensional structure may include a polymer gel electrolyte.

The polymer gel electrolyte may contain a fluororesin.

The expandable and contractible, three-dimensional structure may include a composition including the fluororesin, having undergone compression molding at a surface pressure of 0.5 MPa or more, and then having undergone impregnation with a liquid including the ionic liquid.

The intermediate layer may further include lithium metal.

The intermediate layer may have the expandable and contractible, three-dimensional structure integrated with at least some of the lithium metal and may have a fluorine content of 2.0 at% (atomic percent) or more.

The present invention provides a lithium metal secondary battery having improved durability.

### BRIEF DESCRIPTION OF THE DRAWINGS

FIG. 1 is a perspective view of an example of a lithium metal secondary battery according to an embodiment of the present invention;

FIGS. 2A, 2B, and 2C are diagrams showing an example of a method for producing an expandable and contractible, three-dimensional structure;

FIG. 3 is a view of a three-dimensional structure being expanded during the charge of the lithium metal secondary battery of FIG. 1;

FIG. 4 provides a scanning electron microscopy (SEM) image of a cross-section of a lithium metal secondary battery of Example 7 fully charged at the tenth cycle and provides its SEM-EDM fluorine mapping image; and FIG. 5 is an SEM image showing lithium metal deposition that occurred between a solid electrolyte layer and a porous body layer in a lithium metal secondary battery being charged.

### DETAILED DESCRIPTION OF THE INVENTION

Hereinafter, embodiments of the present invention will be described with reference to the drawings.

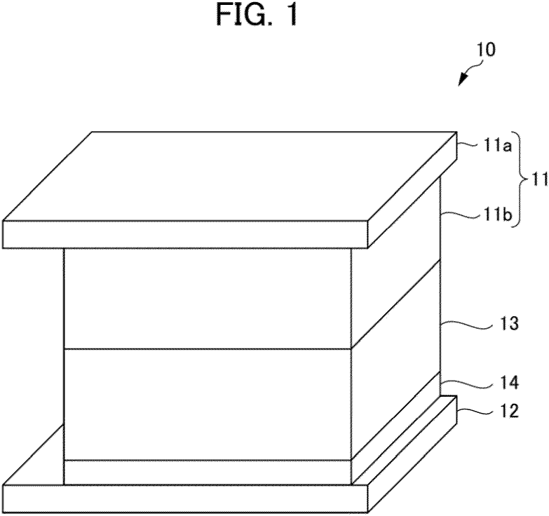

FIG. 1 shows an example of a lithium metal secondary battery according to an embodiment of the present invention.

The lithium metal secondary battery 10 includes a positive electrode 11; a negative electrode current collector 12; a solid electrolyte layer 13 between the positive electrode 11 and the negative electrode current collector 12; and an intermediate layer 14 between the negative electrode current collector 12 and the solid electrolyte layer 13. The positive electrode 11 includes a positive electrode current collector 11a and a positive electrode material mixture layer 11b. The intermediate layer 14 includes an expandable and contractible, three-dimensional structure and lithium metal. An ionic liquid is held within the expandable and contractible, three-dimensional structure.

During the charge of the lithium metal secondary battery 10, the three-dimensional structure expands as lithium metal deposition occurs in the three-dimensional structure of the intermediate layer 14. During the discharge of the lithium metal secondary battery 10, the three-dimensional structure contracts as lithium ions dissolve from the three-dimensional structure of the intermediate layer 14. Therefore, the lithium metal secondary battery 10 may have an initial state in which the intermediate layer 14 contains no lithium metal. In this case, the lithium metal secondary battery 10 is charged before use. This operation causes lithium metal deposition to occur uniformly in the three-dimensional structure of the intermediate layer 14.

The ionic liquid is typically, but not limited to, 1-ethyl-3-methylimidazolium bis(fluorosulfonyl) imide, 1-ethyl-3-methylimidazolium bis(trifluoromethylsulfonyl) imide, N-methyl-N-propyliperidinium bis(trifluoromethanesulfonyl)amide, N,N-diethyl-N-methyl-N-(2-methoxyethyl)ammonium bis(trifluoromethanesulfonyl)amide, or N-methyl-N-propylpyrrolidinium bis(fluorosulfonyl)imide.

The ionic liquid is held in advance within the expandable and contractible, three-dimensional structure. Even during compression molding performed in the process described later, therefore, at least some of the internal space of the intermediate layer 14 remains uncrushed. Concerning this matter, the intermediate layer 14 preferably includes a polymer gel electrolyte. This feature allows the three-dimensional structure to be integrated with at least some of lithium metal being deposited during the charge of the lithium metal secondary battery 10.

The polymer gel electrolyte preferably includes a fluororesin. In this case, fluorine (F) in the fluororesin can electrostatically interact with lithium (Li) to facilitate the integration between the three-dimensional structure and at least some of lithium metal being deposited.

The fluororesin is typically, but not limited to, polyvinylidene fluoride or a vinylidene fluoride-hexafluoropropylene copolymer.

In a case where the three-dimensional structure is integrated with at least some of the deposited lithium metal, the intermediate layer 14 preferably has a fluorine content of 2.0 at% or more, more preferably 5.0 at% or more. The intermediate layer 14 with a fluorine content of 2.0 at% or more will provide improved durability for the lithium metal secondary battery 10.

The polymer gel electrolyte may include a resin other than the fluororesin.

Examples of the resin other than the fluororesin include polyester, polyamide, polyolefin, epoxy resin, acrylic resin, polyurethane, silicon resin, phenolic resin, and modifications of these resins, two or more of which may be used in combination with one another. The resin other than the fluororesin may be a product of copolymerization of two or more of these resins or a modification of such a product of copolymerization.

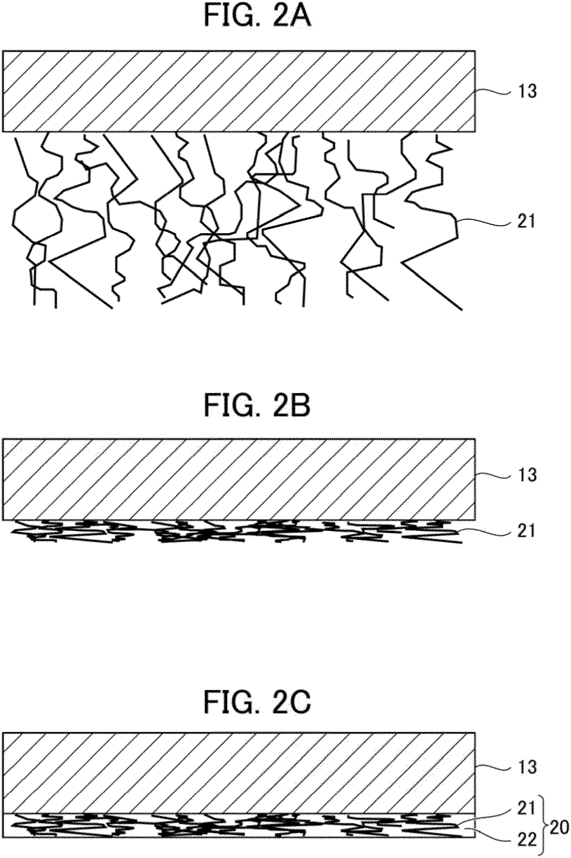

The expandable and contractible, three-dimensional structure may be produced by any suitable method, such as the following method. First, a composition including a fluororesin 21 is placed on a solid electrolyte layer 13 (see FIG. 2A) , and then they are subjected to compression molding (see FIG. 2B). Next, the compression-molded composition is impregnated with a liquid including an ionic liquid 22 (see FIG. 2C), so that the fluororesin 21 swells to form an expandable and contractible, three-dimensional structure 20.

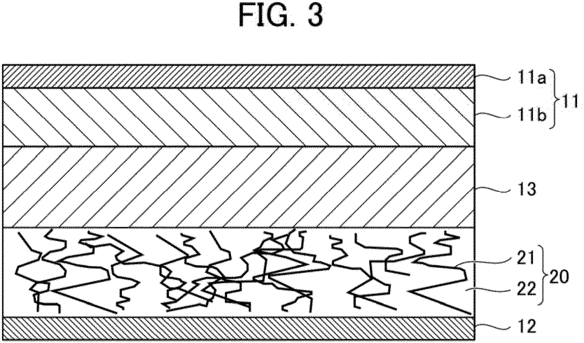

The expandable and contractible, three-dimensional structure 20 has a three-dimensional network structure of the fluororesin 21, within which the ionic liquid 22 is held. During the charge of the lithium metal secondary battery 10, therefore, lithium metal is deposited within the three-dimensional structure 20 to replace some of the ionic liquid 22 held therein and to expand the three-dimensional structure 20 (see FIG. 3).

The compression molding is preferably performed at a surface pressure of 0.2 MPa or more, more preferably at a surface pressure of 5 MPa or less. Compression molding at a surface pressure of 0.5 MPa or more can compress the fluororesin 21 to 20% or more and 40% or less of its initial thickness, which will provide improved durability for the lithium metal secondary battery 10.

The composition preferably has a content of the fluororesin 21 of 4% by mass or more and 12% by mass or less. The composition with a content of the fluororesin 21 of 4% by mass or more will expand in response to lithium metal deposition to provide improved durability for the lithium metal secondary battery 10. The composition with a content of the fluororesin 21 of 12% by mass or less will prevent the fluororesin 21 from reacting with lithium metal or the solid electrolyte in the solid electrolyte layer 13 and thus prevent the degradation of the fluororesin 21, which will help to provide improved durability for the lithium metal secondary battery 10.

The molecular weight of the fluororesin 21 is typically, but not limited to, 50,000 or more and 1,000,000 or less.

The composition including the fluororesin 21 may further contain an ionic liquid, a lithium salt, an additive, or any other component.

The liquid including the ionic liquid 22 may further contain a lithium salt or any other component.

The lithium salt is typically, but not limited to, lithium perchlorate (LiC1O₄), lithium hexafluorophosphate (LiPF₅), lithium tetrafluoroborate (LiBF₄), lithium hexafluoroarsenate (LiAsF₆), lithium difluorophosphate (LIPO₂F₂), lithium trifluoromethanesulfonate (LiCF₃SO₃), lithium bis(fluorosulfonyl)imide (LiN(SO₂F)₂), lithium bis(trifluoromethylsulfonyl)imide (LiN(CF₃SO₂)₂), lithium aluminum tetrafluoride (LiA1F₄), lithium difluorobisoxalate phosphate (LiDFBOP), or lithium nitrate (LiNO₃) .

The additive is typically, but not limited to, vinylene carbonate, fluoroethylene carbonate, poly(ethylene glycol) methyl ether thiol, cesium hexafluorophosphate (CsPF₆), or cesium bis (trifluoromethanesulfonyl)imide (Cs-TFSI).

The ionic liquid in the composition may be the same as or different from the ionic liquid 22 in the liquid. The electrolyte in the composition may be the same as or different from the electrolyte in the liquid.

The thickness of the intermediate layer 14 is typically, but not limited to, 0.1 µm or more and 20 µm or less.

The negative electrode current collector 12 is typically, but not limited to, a copper foil.

The thickness of the negative electrode current collector 12 is typically, but not limited to, 1 µm or more and 50 µm or less.

The positive electrode current collector 11a is typically, but not limited to, an aluminum foil.

The thickness of the positive electrode current collector 11a is typically, but not limited to, 5 µm or more and 50 µm or less.

The positive electrode material mixture layer 11b includes a positive electrode active material and any optional component.

The positive electrode active material may be any suitable material capable of storing and releasing lithium ions, such as a lithium composite oxide.

Examples of the lithium composite oxide include, but are not limited to, LiCoO₂, Li (Ni_{5/10}Co_{2/10}Mn._{5/10})O₂, Li (Ni_{6/10}Co_{2/10} Mn_{2/10})O₂, Li (Ni_{8/10}Co_{⅒}Mn_{⅒})O₂, Li (Ni_{0.8}Co_{0.15}Al_{0.05}) O₂, Li (Ni_{⅙}Co_{4/6}Al_{⅙})O₂, Li (Ni_{⅓}Co_{⅓}Al_{⅓})O₂, LiCoO₄, LiMn₂O₄, LiNiO₂, and LiFePO₄ two or more of which may be used in combination with one another.

The content of the positive electrode active material in the positive electrode material mixture layer 11b is typically, but not limited to, 60% by mass or more and 99% by mass or less.

Examples of the optional component include a solid electrolyte, a conductive aid, and a binder.

The thickness of the positive electrode material mixture layer 11b is typically, but not limited to, 5 µm or more and 50 µm or less.

In the solid electrolyte layer 13, the solid electrolyte may be any suitable material having lithium-ion conductivity, such as an oxide electrolyte or a sulfide electrolyte. In particular, a sulfide electrolyte is preferred, which is reactive with lithium metal and can make the intermediate layer 14 highly effective.

The thickness of the solid electrolyte layer 13 is typically, but not limited to, 10 µm or more and 500 µm or less.

The lithium metal secondary battery 10 includes a stack of the positive electrode 11, the solid electrolyte layer 13, the intermediate layer 14, and the negative electrode current collector 12. During charge, the stack is preferably held under a pressure of 0.2 MPa or more and 5 MPa or less. The pressure of 0.2 MPa or more for holding the stack allows a reduction in contact resistance and allows the lithium metal secondary battery 10 to have high power. Under the pressure of 5 MPa or less for holding the stack, the ionic liquid-containing, expandable and contractible, three-dimensional structure of the intermediate layer 14 is less likely to be pushed out of the stack, which will lead to a reduction in resistance during charge and discharge and to an improvement in the durability of lithium metal secondary battery 10. During the manufacturing of the lithium metal secondary battery 10, therefore, the stack is preferably confined at a surface pressure of 0.5 MPa or more and 3 MPa or less.

The solid electrolyte layer 13 and the intermediate layer 14 may be stacked in any order (in order or reverse order).

Besides the solid electrolyte layer 13, the lithium metal secondary battery 10 may further include an additional electrolyte layer.

The additional electrolyte layer other than the solid electrolyte layer 13 is typically, but not limited to, an electrolytic solution-impregnated separator or a gel electrolyte layer.

### Separator

The separator may be, but not limited to, a porous resin sheet (e.g., a film, a nonwoven fabric).

Examples of the resin in the porous resin sheet include polyethylene (PE), polypropylene (PP), polyester, cellulose, and polyamide.

### Electrolytic Solution

The electrolytic solution may be a solution of an electrolyte in a non-aqueous solvent.

The concentration of the electrolyte in the electrolytic solution is typically, but not limited to, 0.1 mol/L or more and 10 mol/L or less.

The electrolytic solution may contain an additive including at least one compound selected from the group consisting of vinylene carbonate, fluoroethylene carbonate, and propanesultone. Such a compound has the ability to undergo reductive decomposition and to form a solid electrolyte interphase (SEI) coating. When added, therefore, such a compound will be decomposed in preference to the electrolytic solution to form an SEI coating on the negative electrode and thus to improve the durability of the electrolytic solution.

### Non-Aqueous Solvent

Examples of the non-aqueous solvent include, but are not limited to, aprotic solvents, such as carbonates, esters, ethers, nitriles, sulfones, and lactones.

Specific examples of the non-aqueous solvent include ethylene conate (EC), propylene carbonate (PC), diethyl carbonate (DEC), dimethyl carbonate (DMC), ethyl methyl carbonate (EMC), 1,2-dimethozyethane (DME), 1,2-diethoxyethane (DEE), tetrahydrofuran (THF), 2-methyltetrahydrofuran, dioxane, 1,3-dioxolane, diethylene glycol dimethyl ether, ethylene glycol dimethyl ether, acetonitrile (AN), propionitrile, nitromethane, N,N-dimethylformamide (DMF), dimethyl sulfoxide, sulfolane, and γ-butyrolactone.

### Electrolyte

Examples of the electrolyte include, but are not limited to, LiPF₆, LiBF₄, LiClO₄, LiN(SO₂CF₃), LiN(SO₂C₂F₅)₂, LiCF₃SO₃, LiC₄F₉SO₃, LiC(SO₂CF₃)₃, LiF, LiCl, LiI, Li₂S, Li₃N, Li₃P, Li₁₀GeP₂S₁₂ (LGPS), Li₃PS₄, Li₆PS₅Cl, Li₇P₂S₈I, LiₓPO_{y}N_{z} (LiPON), wherein x = 2y + 3z -5, Li₇La₃Zr₂O₁₂ (LLZO), Li₃ₓLa_{⅔-x}TiO₃ (LLTO), Li₁₊ₓAlₓTi₂₋ₓ (PO₄)₃ (LATP), wherein 0 ≤ x ≤ 1, Li₁.₅Al_{0.5}Ge_{1.5}(PO₄)₃ (LAGP), Li_{1+x+y}AlₓTi₂₋ₓSi_{y}P_{3-y}O₁₂, Li_{1+x+y}Alₓ (Ti,Ge)₂₋ₓSi_{y}P_{3-y}O₁₂, and Li₄₋₂ₓZnₓGeO₄ (LISICON), two or more of which may be used in combination with one another. Among them, LiPF₆, LiBF_{4,} or a combination of LiPF₆ and LiBF₄ is preferred.

While some embodiments of the present invention have been described, the embodiments described above are not intended to limit the present invention and may be altered or modified as appropriate without departing from the gist of the present invention.

### EXAMPLES

Hereinafter, examples of the present invention will be described, which are not intended to limit the scope of the present invention.

### Preparation of Positive Electrode

Li(Ni_{0.6}Co_{0.2}Mn_{0.2})O₂ (a positive electrode active material), Li_{3.25}Ge_{0.25}P_{0.75}S₄ (thio-LISICON) (a solid electrolyte), acetylene black (a conductive aid), styrenebutadiene rubber (SBR) (a binder), and butyl butyrate (a solvent) were put into a planetary centrifugal mixer and stirred at 2,000 rpm for 3 minutes. The resulting mixture was then defoamed for 1 minute to give a coating liquid for forming a positive electrode material mixture layer. In the coating liquid, the positive electrode active material, the solid electrolyte, the conductive aid, and the binder were 75:22:3:3 in mass ratio.

The coating liquid was cast on an aluminum foil. (a positive electrode current collector) and heated at 60° C. so that the solvent was removed. The coating on the aluminum foil was then roll-pressed to form a positive electrode having a positive electrode material mixture layer with a density of 3.1 g/cc and a mass per unit area of 26 mg/cm².

### Preparation of Solid Electrolyte Layer

Li_{3.25}Ge_{0.25}P_{0.75}S₄ (thio-LISICON) (a solid electrolyte) powder was compression-molded at a pressure of 150 MPa using a 10 mm-diameter zirconium, tube to form a 10 mm-diameter solid electrolyte layer.

### Preparation of Stack of Positive Electrode and Solid Electrolyte Layer

The positive electrode, which was 10 mm in diameter, and the solid electrolyte layer were stacked and compression-molded at a pressure of 1,000 MPa to form a stack of the positive electrode and the solid electrolyte layer.

### Example 1

### Preparation of Stack of Positive Electrode, Solid Electrolyte Layer, and Intermediate Layer

A coating liquid was prepared by dissolving 0.3 parts by mass of a vinylidene fluoride-hexafluoropropylene copolymer (PVDF-HFP W#8500 manufactured by Kureha Corporation) in 99.7 parts by mass of dimethyl carbonate (DMC).

The coating liquid was applied to the solid electrolyte layer side of the stack of the positive electrode and the solid electrolyte layer and then dried at 60° C. The dried coating was then uniaxially press-molded at a surface pressure of 500 MPa to form a compressed layer. Subsequently, the compressed layer was impregnated with a mixture of 30.6 parts by mass of lithium bis (fluorosulfonyl) imide (LiFSI) (a lithium salt) and 69.4 parts by mass of 1-ethyl-3-methylimidazolium bis (trifluoromethylsulfonyl) imide (EMI-FSI) (an ionic liquid). The compressed layer impregnated with the mixture was then dried at 60° C. to form a polymer gel electrolyte layer (intermediate layer), so that a stack of the positive electrode, the solid electrolyte layer, and the intermediate layer was prepared.

### Preparation of Lithium Metal Secondary Battery

The stack of the positive electrode, the solid electrolyte layer, and the intermediate layer and a copper foil (a negative electrode current collector) were stacked and confined at a surface pressure of 3 MPa for interface bonding between the intermediate layer and the negative electrode current collector to form a lithium metal secondary battery.

### Example 2

### Preparation of Stack of Positive Electrode, Solid Electrolyte Layer, and Intermediate Layer

A stack of the positive electrode, the solid electrolyte layer, and the intermediate layer was prepared as in Example 1 except that the surface pressure during the uniaxial press-molding was changed to 200 MPa and that the compressed layer was impregnated with a mixture of 22.7 parts by mass of LiFSI and 77.3 parts by mass of EMI-FSI.

### Preparation of Lithium Metal Secondary Battery

A lithium metal secondary battery was prepared as in Example 1 except that the resulting stack of the positive electrode, the solid electrolyte layer, and the intermediate layer was used instead.

### Example 3

### Preparation of Stack of Positive Electrode, Solid Electrolyte Layer, and Intermediate Layer

A stack of the positive electrode, the solid electrolyte layer, and the intermediate layer was prepared as in Example 1 except that the surface pressure during the uniaxial press-molding was changed to 50 MPa and that the compressed layer was impregnated with a mixture of 12.8 parts by mass of LiFSI and 87.2 parts by mass of EMI-FSI.

### Preparation of Lithium Metal Secondary Battery

A lithium metal secondary battery was prepared as in Example 1 except that the resulting stack of the positive electrode, the solid electrolyte layer, and the intermediate layer was used instead.

### Example 4

### Preparation of Stack of Positive Electrode, Solid Electrolyte Layer, and Intermediate Layer

A coating liquid was prepared by dissolving 2.0 parts by mass of PVDF-HFP (3500) in 69.5 parts by mass of DMC and then adding, to the solution, a mixture of 3.6 parts by mass of LiFSI and 24.9 parts by mass of EMI-FSI.

The coating liquid was applied to the solid electrolyte layer side of the stack of the positive electrode and the solid electrolyte layer and then dried at 60° C. The dried coating was then uniaxially press-molded at a surface pressure of 300 MPa to form a compressed layer. Subsequently, the compressed layer was impregnated with a mixture of 12.8 parts by mass of LiFSI and 87.2 parts by mass of EMI-FSI. The compressed layer impregnated with the mixture was then dried at 60° C. to form a polymer gel electrolyte layer (intermediate layer), so that a stack of the positive electrode, the solid electrolyte layer, and the intermediate layer was prepared.

### Preparation of Lithium Metal Secondary Battery

A lithium metal secondary battery was prepared as in Example 1 except that the resulting stack of the positive electrode, the solid electrolyte layer, and the intermediate layer was used instead.

### Example 5

### Preparation of Stack of Positive Electrode, Solid Electrolyte Layer, and Intermediate layer

A stack of the positive electrode, the solid electrolyte layer, and the intermediate layer was prepared as in Example 4 except that the surface pressure during the uniaxial press-molding was changed to 100 MPa.

### Preparation of Lithium Metal Secondary Battery

A lithium metal secondary battery was prepared as in Example 1 except that the resulting stack of the positive electrode, the solid electrolyte layer, and the intermediate layer was used instead.

### Example 6

### Preparation of Stack of Positive Electrode, Solid Electrolyte Layer, and Intermediate Layer

A stack of the positive electrode, the solid electrolyte layer, and the intermediate layer was prepared as in Example 4 except that the surface pressure during the uniaxial press-molding was changed to 5 MPa.

### Preparation of Lithium Metal Secondary Battery

A lithium metal secondary battery was prepared as in Example 1 except that the resulting stack of the positive electrode, the solid electrolyte layer, and the intermediate layer was used instead.

### Example 7

### Preparation of Stack of Solid Electrolyte Layer, intermediate Layer, and Negative Electrode Current Collector

A coating liquid was prepared by dissolving 2.0 parts by mass of PVDF-HFP W#8500 (manufactured by Kureha Corporation) in 69.5 parts by mass of DMC and then adding, to the solution, a mixture of 3.6 parts by mass of LiFSI and 24.9 parts by mass of EMI-FSI.

The coating liquid was applied to a copper foil (a negative electrode current collector) and then dried at room temperature. The solid electrolyte layer was placed on the dried coating. The dried coating between the solid electrolyte layer and the copper foil was then subjected to uniaxial press-molding at a surface pressure of 30 MPa to form a compressed layer. Subsequently, the compressed layer was impregnated with a mixture of 12.8 parts by mass of LiFSI and 87.2 parts by mass of EMI-FSI. The compressed layer impregnated with the mixture was then dried at 60° C. to form a polymer gel electrolyte layer (intermediate layer), so that a stack of the solid electrolyte layer, the intermediate layer, and the negative electrode current collector was prepared.

### Preparation of Lithium Metal Secondary Battery

The positive electrode and the stack of electrolyte layer, the intermediate layer, and the negative electrode current collector were stacked and confined at a surface pressure of 3 MPa for interface bonding between the positive electrode material mixture layer and the solid electrolyte layer to form a lithium metal secondary battery.

### Example 8

### Preparation of Stack of Solid Electrolyte Layer, Intermediate Layer, and Negative Electrode Current Collector

A coating liquid was prepared by dissolving 2.0 parts by mass of PVDF-HFP W#8500 (manufactured by Kureha Corporation) in 69.5 parts by mass of DMC and then adding, to the solution, a mixture of 3.6 parts by mass of LiFSI and 24.9 parts by mass of EMI-FSI.

The coating liquid was applied to a copper foil (a negative electrode current collector) and then dried at room temperature. The solid electrolyte layer was placed on the dried coating. The dried coating between the solid electrolyte layer and the copper foil was then subjected to uniaxial press-molding at a surface pressure of 70 MPa to form a polymer gel electrolyte layer (intermediate layer), so that a stack of the solid electrolyte layer, the intermediate layer, and the negative electrode current collector was prepared.

### Preparation of Lithium Metal Secondary Battery

A lithium metal secondary battery was prepared as in Example 7 except that the resulting stack of the solid electrolyte layer, the intermediate layer, and the negative electrode current collector was used instead.

### Comparative Example 1

### Preparation of Stack of Solid Electrolyte Layer and Intermediate Layer

A coating liquid was prepared by dissolving 0.3 parts by mass of PVDF-HFP (8500) in 99.7 parts by mass of DMC.

The coating liquid was applied to the solid electrolyte layer and then dried at 60° C. to form a non-compressed layer (intermediate layer), so that a stack of the solid electrolyte layer and the intermediate layer was prepared.

### Preparation of Lithium Metal Secondary Battery

A lithium metal secondary battery was prepared as in Example 1 except that the resulting stack of the solid electrolyte layer and the intermediate layer was used instead.

### Comparative Example 2

### Preparation of Stack of Solid Electrolyte Layer and Intermediate Layer

A coating liquid was prepared by dissolving 0.3 parts by mass of PVDF-HFP (8500) in 99.7 parts by mass of DMC.

The coating liquid was applied to the solid electrolyte layer and then dried at room temperature. The dried coating was then uniaxially press-molded at a surface pressure of 0.01 MPa to form a compressed layer (intermediate layer), so that a stack of the solid electrolyte layer and the intermediate layer was prepared.

### Preparation of Lithium Metal Secondary Battery

A lithium metal secondary battery was prepared as in Example 1 except that the resulting stack of the solid electrolyte layer and the intermediate layer was used instead.

### Initial Performance

The resulting all-solid-state lithium metal secondary battery was subjected to 3 cycles of constant current (CC)-constant voltage (CV) charge and CC discharge, during which the charge capacity at ⅒ C in the first cycle and the discharge capacity at ⅒ C in the first cycle were determined. The charge-discharge efficiency was calculated from the formula: ((the discharge capacity)/(the charge capacity)} x 100.

In the third cycle, CC-CV charge was performed as in the first and second cycles, and then the battery was subjected to constant-current discharge at a voltage for SOC 50% in a thermostatic chamber at 60° C., 10 seconds after which the voltage was measured. The direct current resistance (DCR) was calculated from the slope between the current and the voltage measured after 10 seconds.

### Durability Performance

Ten charge-discharge cycles were performed in the same manner as above. The charge-discharge efficiency was calculated from the formula: ((the discharge capacity at ⅒ C in the tenth cycle) / (the charge capacity at ⅒ C in the tenth cycle)} x 100. The capacity retention rate was also calculated from the formula: {(the discharge capacity in the tenth cycle)/(the discharge capacity)} x 100.

Fluorine Content of Lithium Metal-Containing Intermediate Layer

An SEM image of a cross-section of the battery fully charged in the tenth cycle was observed, and SEM-SXES fluorine mapping was performed on the SEM image, from which the fluorine content of the lithium metal-containing intermediate layer was determined.

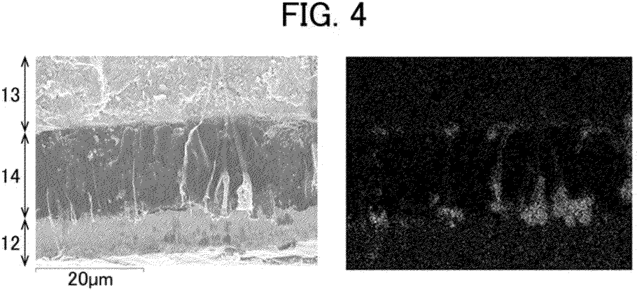

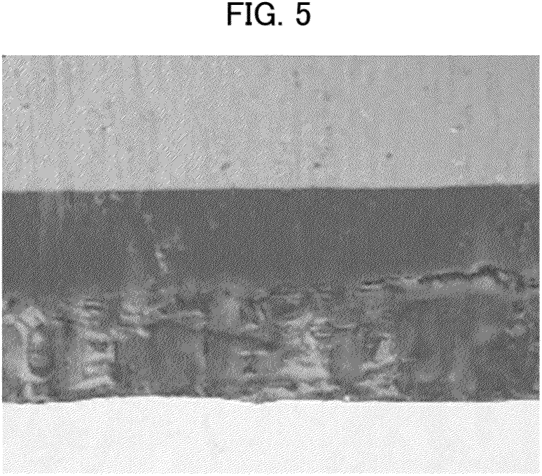

FIG. 4 provides the SEM image of the cross-section of the lithium metal secondary battery of Example 7 fully charged in the tenth cycle and provides its fluorine mapping image.

FIG. 4 shows that fluorine is distributed over the intermediate layer 14 mainly at the interface with the negative electrode current collector 12 and at the interface with the solid electrolyte layer 13. This suggests that lithium metal deposition occurred within the three-dimensional structure of the intermediate layer 14 and that the three-dimensional structure was integrated with at least some of the deposited lithium metal. A porous structure of lithium metal was not observed.

Table 1 shows the results of evaluation of the initial performance and durability performance of the lithium metal secondary batteries and the results of evaluation of the fluorine content of the lithium metal-containing intermediate layers.

TABLE 1

indicates that the lithium metal secondary batteries of Examples 1 to 8 have high durability

| | Initial performance | | | | Durability performance | | F content of L) metal-containing intermediate layer [at%] |
|---|---|---|---|---|---|---|---|
| | Charge capacity [mAh] | Discharge capacity [mAh] | Charge-discharge efficiency [%] | DCR [Ω/cm²] | Charge-discharge efficiency [%] | Charge retention rate [%] | |
| Example1 | 3.09 | 2.20 | 71.3 | 30 | 95.1 | 40.5 | 2.1 |
| Example2 | 3.01 | 2.31 | 76.7 | 28 | 94.2 | 41.2 | 2.5 |
| Example3 | 2.98 | 1.89 | 63.4 | 28 | 93.8 | 39.8 | 2.3 |
| Example4 | 2.99 | 1.57 | 53.6 | 23 | 99.5 | 85.2 | 4.3 |
| Example5 | 2.50 | 1.58 | 63.2 | 25 | 99.3 | 84.3 | 3.5 |
| Example6 | 2.81 | 1.60 | 56.9 | 24 | 99.0 | 84.1 | 4.2 |
| Example7 | 2.77 | 2.04 | 73.5 | 24 | 99.7 | 86.3 | 4.1 |
| Example8 | 2.80 | 1.94 | 69.3 | 23 | 99.5 | 83.5 | 3.8 |
| Comparative Example1 | 3.23 | 1.46 | 45.2 | 40 | 81.6 | 3.9 | 0.3 |
| Comparative Example2 | 3.20 | 1.55 | 48.4 | 41 | 81.3 | 3.8 | 0.4 |

In contrast, the lithium metal secondary batteries of Comparative Examples 1 and 2 have low durability because the intermediate layer neither has an expandable and contractible, three-dimensional structure nor contains any ionic liquid.

### Example 9

### Preparation of Positive Electrode

A conductive aid and polyvinylidene fluoride (PVDF) (a binder) were mixed and dispersed using a planetary centrifugal mixer. The resulting dispersion and Li₁Ni_{0.8}Co_{0.1}Mn_{0.1}O₂ (NCM811) (a positive electrode active material) were then mixed using a planetary mixer. Subsequently, N-methyl-N-pyrrolidone (NMP) was added to the mixture to form a positive electrode material mixture paste. The positive electrode material mixture paste was applied to an aluminum (Al) current collector and then dried. Subsequently, the dried paste on the current collector was roll-pressed and then dried in vacuo at 120° C. to form a positive electrode plate. The electrode plate was subjected to punching so that a positive electrode of 30 mm × 40 mm was obtained before use. The thickness of the positive electrode was 70 µm.

### Preparation of Negative Electrode

20 µm-thick LiCu foil was subjected to punching so that a negative electrode of 32 mm × 42 mm was obtained before use.

### Preparation of Stack of Positive Electrode, Separator, Intermediate Layer, and Negative Electrode

A coating liquid was prepared by dissolving 3.0 parts by mass of PVDF-HFP W#8500 (manufactured by Kureha Corporation) in 68.5 parts by mass of DMC and then adding, to the solution, a mixture of 4.4 parts by mass of LiFSI and 24.1 parts by mass of 1-methyl-1-propylpyrrolidinium bis(trifluoromethylsulfonyl)imide (MPPy-FSI).

The coating liquid was applied to a separator and then dried at 80° C. Subsequently, the separator with the dried coating was placed between the positive and negative electrodes and then subjected to uniaxial press-molding at a surface pressure of 0.2 MPa to form a stack of the positive electrode, the separator, a polymer gel electrolyte layer (intermediate layer), and the negative electrode.

### Preparation of Lithium Metal Secondary Battery

An aluminum laminate (manufactured by Dai Nippon Printing Co., Ltd.) for secondary batteries was heat-sealed to form a bag-shaped container. The stack of the positive electrode, the separator, the intermediate layer, and the negative electrode was put into the container. A solution of 5 mol/L LiFSI in a mixture of EC and DMC (3:7 in volume ratio) (an electrolytic solution) was then injected into the separator, so that a lithium metal secondary battery was prepared.

### Charge-Discharge Test

The lithium metal secondary battery was subjected to a charge-discharge test. In the first charge-discharge test, the battery was charged at a rate of 0.2 C to 4.3 V and discharged at a rate of 0.2 C to 2.65 V. The battery was then charged at a rate of 0.3 C to 4.3 V and discharged at a rate of 0.3 C to 2.65 V.

As a result, the battery was found to have an initial cell capacity of 48.0 mAh. After a 50-cycle durability test, the capacity retention rate of the battery was calculated to be 90% from the formula: ((the cell capacity after the 50-cycle durability test)/(the initial cell capacity)} × 100, in which the current for discharge at 0.3 C was normalized to 100.

### Comparative Example 3

### Preparation of Lithium Metal Secondary Battery

A lithium metal secondary battery was prepared as in Example 9 except that a stack of the positive electrode, the separator, and the negative electrode was put into the bag-shaped container formed by heat-sealing an aluminum laminate (manufactured by Dai Nippon Printing Co., Ltd.) for secondary batteries and then the electrolytic solution was injected into the separator.

### Charge-Discharge Test

As a result of a charge-discharge test performed as in Example 9, the battery was found to have an initial cell capacity of 48.2 mAh. After the durability test, the capacity retention rate of the battery was calculated as in Example 9. The calculated value was 25%.

### EXPLANATION OF REFERENCE NUMERALS

10: Lithium metal secondary battery
11: Positive electrode
11a: Positive electrode current collector
11b: Positive electrode material mixture layer
12: Negative electrode current collector
13: Solid electrolyte layer
14: Intermediate layer

What is claimed is:

1. A lithium metal secondary battery, comprising:
a positive electrode;
a negative electrode current collector;
an electrolyte layer provided between the positive electrode and the negative electrode current collector;
an intermediate layer provided between the positive electrode and the negative electrode current collector and comprising an expandable and contractible, three-dimensional structure; and
an ionic liquid held within the expandable and contractible, three-dimensional structure.

2. The lithium metal secondary battery according to claim 1, wherein the electrolyte layer is provided between the positive electrode and the intermediate layer.

3. The lithium metal secondary battery according to claim 1, wherein the electrolyte layer is a solid electrolyte layer.

4. The lithium metal secondary battery according to claim 1, wherein the expandable and contractible, three-dimensional structure comprises a polymer gel electrolyte.

5. The lithium metal secondary battery according to claim 4, wherein the polymer gel electrolyte contains a fluororesin.

6. The lithium metal secondary battery according to claim 5, wherein the expandable and contractible, three-dimensional structure comprises a composition comprising the fluororesin, having undergone compression molding, and then having undergone impregnation with a liquid comprising the ionic liquid.

7. The lithium metal secondary battery according to claim 1, wherein the intermediate layer further comprises lithium metal.

8. The lithium metal secondary battery according to claim 7, wherein the intermediate layer has the expandable and contractible, three-dimensional structure integrated with at least some of the lithium metal and has a fluorine content of 2.0 at% or more.
